(19) United States
(12) Patent Application Publication
(10) Pub. No.: US 2026/0300423 A1
(43) Pub. Date: Oct. 1, 2026

(54) GENERATIVE SEMANTIC CACHING AND MODEL DISTILLATION IN NATURAL LANGUAGE PROCESSING

(71) Applicant: Cisco Technology, Inc., San Jose, CA (US)

(72) Inventors: Ali Payani, Cupertino, CA (US); Advit Deepak, San Jose, CA (US); Jayanth Srinivasa, Newark, CA (US); Mahesh Viswanathan, White Plains, NY (US); Ramana Rao V.R. Kompella, Foster City, CA (US); Gaowen Liu, Naperville, IL (US)

(73) Assignee: Cisco Technology, Inc., San Jose, CA (US)

(21) Appl. No.: 19/091,171

(22) Filed: Mar. 26, 2025

(51) Int. Cl. G06F 16/957; G06F 40/30; G06N 5/022

(52) U.S. Cl. CPC G06F 16/957; G06F 40/30; G06N 5/022

(57) ABSTRACT

In one implementation, a device may obtain a prompt to a query service from a client. The device may determine whether a cache containing previously stored prompt-response pairs includes a match for the prompt based on a similarity metric. The device may generate a response to the prompt using a student language model trained on prompt-response data from the cache. The device may determine, based on an assessment of the response generated by the student language model, whether to return the response generated by the student language model to the client or to escalate the prompt to a main language model for response generation.

### TECHNICAL FIELD

The present disclosure relates generally to computer networks, and, more particularly, to generative semantic caching and model distillation in natural language processing.

### BACKGROUND

Recent advancements in artificial intelligence models (e.g., language models such as large language models (LLMs)), have opened new possibilities across various industries. Specifically, the ability of these models to follow instructions enables their integration with tools (e.g., plugins) that are able to perform tasks such as searching the web, executing code, etc. Additionally, agents can be designed to perform tasks by chaining multiple calls to one or more models. For instance, an initial step may involve formulating a plan in natural language, and subsequent steps in executing on this plan by writing code to call application programming interfaces (APIs) or libraries.

However, processing complex prompts with these models can be time-consuming (e.g., on the order of the minutes to process) and resource intensive. Furthermore, within organizations users frequently issued identical or similar prompts over time. As a result, redundant processing may operate as a substantial time and resource cost center.

One approach to reducing redundant processing may include the implementation of caching strategies. In caching, prompt-response pairs may be stored and/or reused such that when a user issues a prompt that was previously sent to the LLM, the caching mechanism can return the cached answer, rather than sending that prompt to the LLM. However, conventional caching strategies can be insufficient for providing the best responses and maximizing cache hit rates. For example, strict reliance on finding the best matching prompt-response pair may result in a suboptimal response or a cache miss when a combination of cached responses provides a better response to a client query than the response corresponding to the cached prompt with the closest semantic match to the client query.

### BRIEF DESCRIPTION OF THE DRAWINGS

The implementations herein may be better understood by referring to the following description in conjunction with the accompanying drawings in which like reference numerals indicate identically or functionally similar elements, of which:

FIG. 1 illustrates an example computing system;

FIG. 2 illustrates an example network device/node;

FIG. 3 illustrates an example of a user interfacing with a generative model;

FIG. 4 illustrates an example architecture for an artificial intelligence (AI) agent;

FIG. 5 illustrates an example of a framework for hierarchical model training and cache utilization in prompt processing;

FIG. 6 illustrates an example of a technique for semantic matching with coverage analysis in a generative caching system;

FIG. 7 illustrates an example of a technique for graph matching in a generative caching system; and

FIG. 8 illustrates an example of a simplified procedure for generative cache utilization in natural language prompt processing, in accordance with one or more implementations described herein.

### DESCRIPTION OF EXAMPLE IMPLEMENTATIONS

### Overview

According to one or more implementations of the disclosure, a device may obtain a prompt to a query service from a client. The device may determine whether a cache containing previously stored prompt-response pairs includes a match for the prompt based on a similarity metric. The device may generate a response to the prompt using a student language model trained on prompt-response data from the cache. The device may determine, based on an assessment of the response generated by the student language model, whether to return the response generated by the student language model to the client or to escalate the prompt to a main language model for response generation.

Other implementations are described below, and this overview is not meant to limit the scope of the present disclosure.

### Description

A computer network is a geographically distributed collection of nodes interconnected by communication links and segments for transporting data between end nodes, such as personal computers and workstations, or other devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, and others. The Internet is an example of a WAN that connects disparate networks throughout the world, providing global communication between nodes on various networks. Other types of networks, such as field area networks (FANs), neighborhood area networks (NANs), personal area networks (PANs), enterprise networks, etc. may also make up the components of any given computer network. In addition, a Mobile Ad-Hoc Network (MANET) is a kind of wireless ad-hoc network, which is generally considered a self-configuring network of mobile routers (and associated hosts) connected by wireless links, the union of which forms an arbitrary topology.

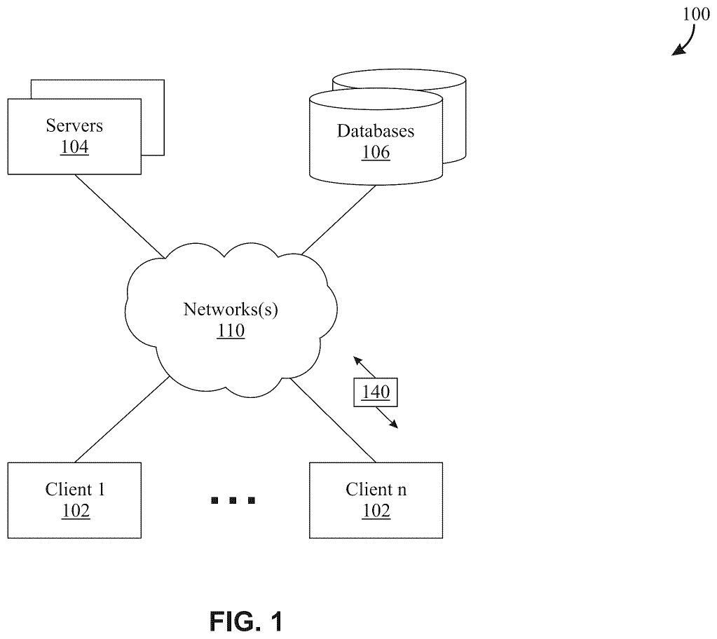

FIG. 1 is a schematic block diagram of an example simplified computing system (e.g., computing system 100) illustratively comprising any number of client devices (e.g., client devices 102 (e.g., a first through nth client device), one or more servers (e.g., servers 104), and one or more databases (e.g., databases 106), where the devices may be in communication with one another via any number of networks (e.g., network(s) 110). The one or more networks (e.g., network(s) 110) may include, as would be appreciated, any number of specialized networking devices such as routers, switches, access points, etc., interconnected via wired and/or wireless connections. For example, devices 102-104 and/or the intermediary devices in network(s) 110 may communicate wirelessly via links based on WiFi, cellular, infrared, radio, near-field communication, satellite, or the like. Other such connections may use hardwired links, e.g., Ethernet, fiber optic, etc. The nodes/devices typically communicate over the network by exchanging discrete frames or packets of data (packets 140) according to predefined protocols, such as the Transmission Control Protocol/Internet Protocol (TCP/IP) other suitable data structures, protocols, and/or signals. In this context, a protocol consists of a set of rules defining how the nodes interact with each other.

Client devices 102 may include any number of user devices or end point devices configured to interface with the techniques herein. For example, client devices 102 may include, but are not limited to, desktop computers, laptop computers, tablet devices, smart phones, wearable devices (e.g., heads up devices, smart watches, etc.), set-top devices, smart televisions, Internet of Things (IoT) devices, autonomous devices, or any other form of computing device capable of participating with other devices via network(s) 110.

Notably, in some implementations, servers 104 and/or databases 106, including any number of other suitable devices (e.g., firewalls, gateways, and so on) may be part of a cloud-based service. In such cases, the servers and/or databases 106 may represent the cloud-based device(s) that provide certain services described herein, and may be distributed, localized (e.g., on the premise of an enterprise, or “on prem”), or any combination of suitable configurations, as will be understood in the art.

Those skilled in the art will also understand that any number of nodes, devices, links, etc. may be used in computing system 100, and that the view shown herein is for simplicity. Also, those skilled in the art will further understand that while the network is shown in a certain orientation, the computing system 100 is merely an example illustration that is not meant to limit the disclosure.

Notably, web services can be used to provide communications between electronic and/or computing devices over a network, such as the Internet. A web site is an example of a type of web service. A web site is typically a set of related web pages that can be served from a web domain. A web site can be hosted on a web server. A publicly accessible web site can generally be accessed via a network, such as the Internet. The publicly accessible collection of web sites is generally referred to as the World Wide Web (WWW).

Also, cloud computing generally refers to the use of computing resources (e.g., hardware and software) that are delivered as a service over a network (e.g., typically, the Internet). Cloud computing includes using remote services to provide a user's data, software, and computation.

Moreover, distributed applications can generally be delivered using cloud computing techniques. For example, distributed applications can be provided using a cloud computing model, in which users are provided access to application software and databases over a network. The cloud providers generally manage the infrastructure and platforms (e.g., servers/appliances) on which the applications are executed. Various types of distributed applications can be provided as a cloud service or as a Software as a Service (SaaS) over a network, such as the Internet.

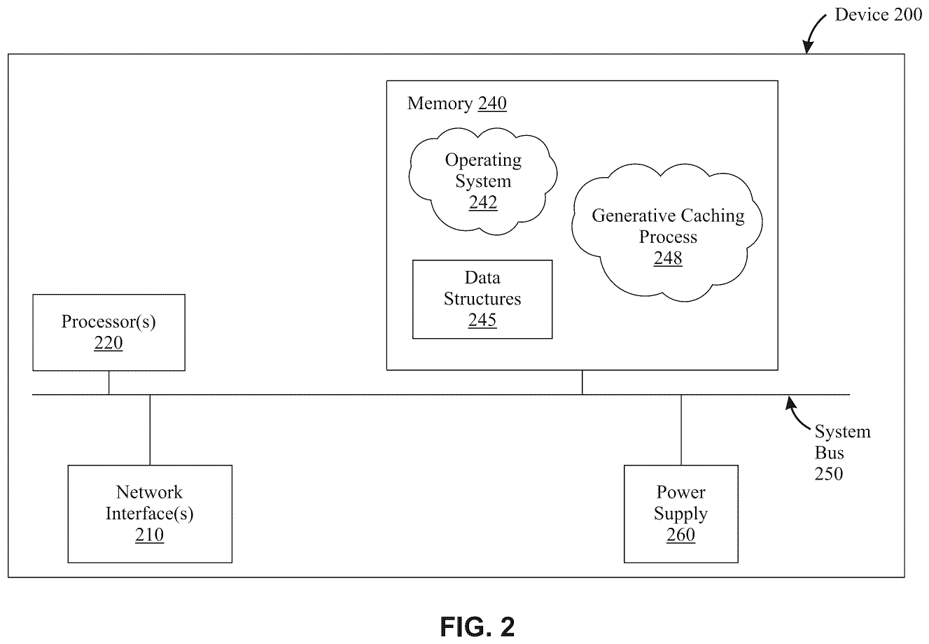

FIG. 2 is a schematic block diagram of an example node/device 200 (e.g., an apparatus) that may be used with one or more implementations described herein, e.g., as any of the nodes or devices shown in FIG. 1 above or described in further detail below. The device 200 may comprise one or more of the network interfaces 210 (e.g., wired, wireless, etc.), at least one processor (e.g., processor(s) 220), and a memory 240 interconnected by a system bus 250, as well as a power supply 260 (e.g., battery, plug-in, etc.).

The network interfaces 210 include the mechanical, electrical, and signaling circuitry for communicating data over physical links coupled to the computing system 100. The network interfaces may be configured to transmit and/or receive data using a variety of different communication protocols. Notably, a physical network interface (e.g., network interfaces 210) may also be used to implement one or more virtual network interfaces, such as for virtual private network (VPN) access, known to those skilled in the art.

The memory 240 comprises a plurality of storage locations that are addressable by the processor(s) 220 and the network interfaces 210 for storing software programs and data structures associated with the implementations described herein. The processor(s) 220 may comprise necessary elements or logic adapted to execute the software programs and manipulate the data structures 245. An operating system 242 (e.g., the Internetworking Operating System, or IOS®, of Cisco Systems, Inc., another operating system, etc.), portions of which are typically resident in memory 240 and executed by the processor(s), functionally organizes the node by, inter alia, invoking network operations in support of software processes and/or services executing on the device. These software processes and/or services may comprise one or more functional processes, and on certain devices, a generative caching process 248, as described herein. Notably, the functional processes, when executed by processor(s) 220, may cause each device 200 to perform the various functions corresponding to the particular device's purpose and general configuration. For example, a router would be configured to operate as a router, a server would be configured to operate as a server, an access point (or gateway) would be configured to operate as an access point (or gateway), a client device would be configured to operate as a client device, and so on.

It will be apparent to those skilled in the art that other processor and memory types, including various computer-readable media, may be used to store and execute program instructions pertaining to the techniques described herein. Also, while the description illustrates various processes, it is expressly contemplated that various processes may be implemented as modules configured to operate in accordance with the techniques herein (e.g., according to the functionality of a similar process). Further, while processes may be shown and/or described separately, those skilled in the art will appreciate that processes may be routines or modules within other processes.

In various implementations, as detailed further below, generative caching process 248 may include computer executable instructions that, when executed by processor(s) 220, cause device 200 to perform the techniques described herein. For example, generative caching process 248 may include computer-executable instructions stored on a computer-readable medium that are executable by processor(s) 220 to cause node/device 200 to perform a portion of operations associated generative semantic caching and model distillation in natural language processing.

To do so, in some implementations, generative caching process 248 may utilize and/or be part of a machine learning system. In general, machine learning is concerned with the design and the development of techniques that take as input empirical data (such as network statistics and performance indicators) and recognize complex patterns in these data. One very common pattern among machine learning techniques is the use of an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function would be the number of misclassified points. The learning process then operates by adjusting the parameters a, b, c such that the number of misclassified points is minimal. After this optimization phase (or learning phase), model M can be used very easily to classify new data points. Often, M is a statistical model, and the cost function is inversely proportional to the likelihood of M, given the input data.

In various implementations, generative caching process 248 may employ and/or be part of one or more supervised, unsupervised, or semi-supervised machine learning models. Generally, supervised learning entails the use of a training set of data, as noted above, that is used to train the model to apply labels to the input data. For example, the training data may include sample telemetry or other data that has been labeled as being indicative of an acceptable performance or unacceptable performance. On the other end of the spectrum are unsupervised techniques that do not require a training set of labels. Notably, while a supervised learning model may look for previously seen patterns that have been labeled as such, an unsupervised model may instead look to whether there are sudden changes or patterns in the behavior of the metrics. Semi-supervised learning models take a middle ground approach that uses a greatly reduced set of labeled training data.

Example machine learning techniques that the generative caching process 248 can employ may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), long short-term memory (LSTM), logistic or other regression, Markov models or chains, principal component analysis (PCA) (e.g., for linear models), singular value decomposition (SVD), multi-layer perceptron (MLP) artificial neural networks (ANNs) (e.g., for non-linear models), replicating reservoir networks (e.g., for non-linear models, typically for timeseries), random forest classification, or the like.

In further implementations, generative caching process 248 may also include and/or be part of one or more generative artificial intelligence/machine learning models. In contrast to discriminative models that simply seek to perform pattern matching for purposes such as anomaly detection, classification, or the like, generative approaches instead seek to generate new content or other data (e.g., audio, video/images, text, etc.), based on an existing body of training data. For instance, in the context of persistent machine learning models, generative caching process 248 may use a generative model for intelligent generative caching, LLM model distillation, and/or cache utilization processes. Example generative approaches can include, but are not limited to, generative adversarial networks (GANs), foundation models such as large language models (LLMs), other transformer models, and the like.

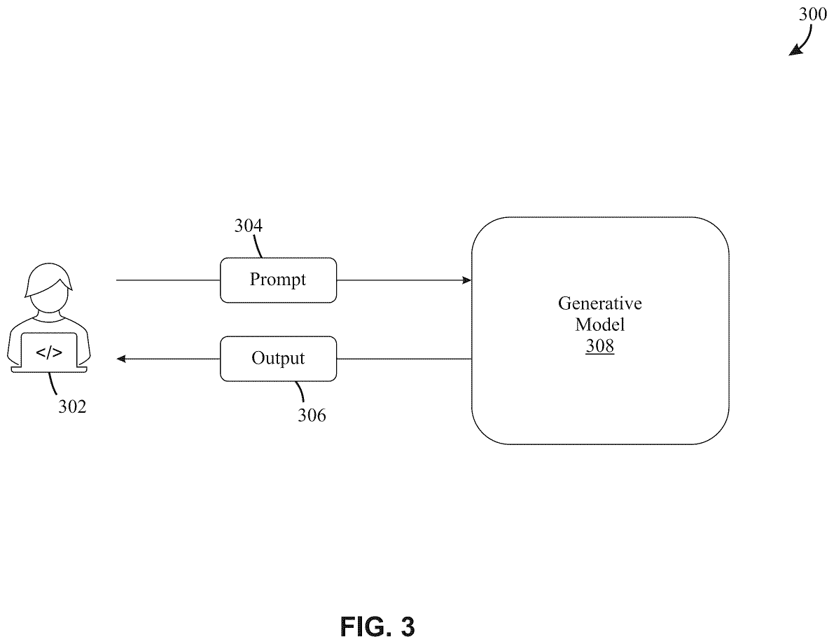

FIG. 3 illustrates an example 300 for interfacing with a generative model, in various implementations. In example 300, a user 302 may send a prompt 304 (e.g., a query, a query augmented with additional data, documents, and/or images, etc.) to a generative model 308. The generative model 308 may be configured to process a prompt 304 to generate an output 306 to satisfy the prompt 304.

The generative model 308 may be a model configured to apply its trained algorithms to generate a response (e.g., output 306) based on the prompt 304 provided. For instance, in some cases, generative model 308 may take the form of a large language model (LLM) or other foundation model, diffusion-based model, combinations thereof, or the like.

The output 306 may be the result produced by the generative model 308 (e.g., by the application of the generative model 308 to the prompt 304). This output can vary depending on the model's configuration and the task at hand. For example, the output 306 may include one or more of a generated/synthesized image, a text response, a classification, a prediction, etc.

As noted above, AI agents are also capable of interacting with generative models, such as generative model 308, which may be integrated directly into the agent or accessed via an API. Indeed, the recent breakthroughs in large language models (LLMs), such as GPT-4, as well as other generative models, represent new opportunities across a wide spectrum of industries. More specifically, the ability of these models to follow instructions now allow for interactions with tools (also called plugins) that are able to perform tasks such as searching the web, executing code, etc. In addition, agents can be written to perform complex tasks by chaining multiple calls to one or more LLMs. For example, a first step can consist in formulating a plan in natural language, and subsequent steps in executing on this plan by writing code to call application programming interfaces (APIs) or libraries.

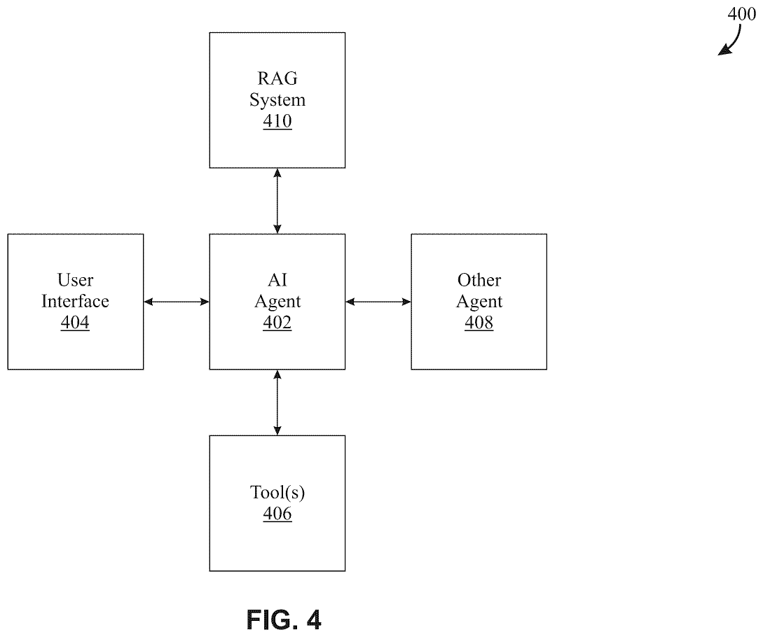

FIG. 4 illustrates an example architecture 400 for an artificial intelligence (AI) agent, according to various implementations. At the core of architecture 400 is AI agent 402, which may be implemented through execution of AI process 248.

As shown, AI agent 402 may interact with a user via a user interface 404. For instance, a user may issue a prompt to AI agent 402 that seeks an answer to a question, performance of a certain task, or the like. In turn, AI agent 402 may use its associated model to formulate a response.

Also as shown, AI agent 402 may interact with tools 406. In general, tools 406 may take the form of interfaces that allow AI agent 402 to interact with any number of systems, in its efforts to produce a response for its input request. For instance, tools 406 may allow AI agent 402 to perform searches (e.g., web searches, searches within a given application or database, etc.), send control commands, or perform other actions, as needed.

In various implementations, AI agent 402 may also be part of an agentic system whereby multiple AI agents interact with one another to formulate a response to an input request. Indeed, the tools, models, etc. available to any given agent may differ across the agentic system. Consequently, different agents may have different capabilities and specialties. Thus, in some implementations, AI agent 402 may also interact with other agent 408, to aid in formulating a final response to its input request. Typically, other agent 408 is executed by a different device than that of the device execution AI agent 402, meaning that AI agent 402 and other agent 408 may communicate via a computer network. In other implementations, though, both agents may be executed by the same device, in further implementations.

For instance, assume that other agent 408 uses a model that has be specialized using knowledge about computer networks and interfaces with tools capable of interacting with a computer network (e.g., to retrieve information, make configuration changes, etc.). Now, assume that the user of user interface 404 issues a query to AI agent 402 asking why the performance of their videoconferencing application is poor. Further, assume that AI agent 402 uses a model that has been specialized on knowledge about the videoconferencing application and able to interact with that application via tools 406. If its initial assessment of the operation of the videoconferencing application is that everything appears to be performing well at the server level, AI agent 402 may then issue a request to other agent 408, to see whether the root cause of the poor performance is the computer network itself.

In some implementations, AI agent 402 may also interact with, or include, a retrieval augmented generation (RAG) system, such as RAG system 410. In general, RAG systems operate by enhancing a prompt for input to a generative model (e.g., an LLM) with additional context. Typically, underlying a RAG system is a dataset of documents or other information that is in a particular domain. For instance, consider the case of AI agent 402 generating a prompt that asks its LLM to make an assessment regarding a computer network. In the case of a general LLM, the LLM may not have specialized knowledge regarding the devices in the network (e.g., command line interface commands, information about the topology of the network, etc.). In such a case, RAG system 410 may modify the prompt, prior to input to the LLM, to provide this additional context, thereby improving the quality of the response and avoiding hallucinations. Typically, a RAG system stores this contextual information in a vector database for quick retrieval using semantic searching.

As noted above, caching has the potential to be of significant benefit for accessing language models to potentially ameliorate their high latencies (e.g., often in the range from a small number of seconds to well over a minute). Furthermore, language model utilization relies on the allocation and use of computational resources (e.g., resources allocated, used, and/or consumed in processing and satisfying a query such as hardware, software, bandwidth, power, GPUs, memory, time or latency, tokens, SLA impacts, etc.). The computational resource demands associated with providing a language model and/or with utilizing a language model (e.g., third party language models, public language models, private language models, enterprise language models, internal language models, external language models, etc.) can be significant. Caching language model data may ameliorate some of this spend when it is then leveraged (e.g., substituted for processing of a prompt by a language model) to reduce the amount of repetitive utilization and/or processing by the language models.

However, conventional caching strategies only utilize static caches. Information is given, converted to embeddings, and answers are stored in the exact same words as they were generated. The conventional approaches are not capable of rephrasing or incorporating this statically cached knowledge into similar queries as there is no understanding of this cached information. This leads to an overall un-usability of cached information, as it is rarely useful to provide the exact same answer when using generative systems. Therefore, the application of traditional caching strategies to language model utilization may result in lower cache hit rates as well as lower quality responses from the cache (e.g., provide incomplete answers, repetitive answers, etc.); lower cache hit rates, and insufficient answers may increase computational resource demand and/or consumption by requiring additional repetitive prompting and prompt processing.

### Generative Semantic Caching and Model Distillation in Natural Language Processing

In contrast, the techniques herein introduce a mechanism for generative semantic caching and model distillation in natural language processing. Here, generative caching is implemented using a hierarchical structure where the same data (e.g., user prompt, system response, etc. is collected, but instead of just being stored, it is used to train a model to operate as a generative cache.

For example, a model trained on multiple cached responses can be used to synthesize an original answer to a query that has never been seen before. Leveraging these techniques, generative cache may function as a repository of valuable information which can be analyzed and mined to address subset queries.

Generative caches may be leveraged to synthesize and provide accurate comprehensive responses without incurring the computational resource demands and/or latency of prompt processing by a main large language model and may improve the performance and efficiency of language model utilization from the user's perspective. These techniques may be leveraged to tailor caching to optimally balance computational resource demands, latency reduction, the quality of responses provided, etc.

The techniques described herein may be applicable regardless of how the natural language is generated (e.g., using a model or not using a model, leveraging natural language content directly produced by human beings, etc.). That is, the generative caching techniques described herein are not dependent on whether or not a model is used to generate the natural language being cached by these techniques.

Illustratively, the techniques described herein may be performed by hardware, software, and/or firmware, such as in accordance with generative caching process 248, which may include computer executable instructions executed by the processor(s) 220 (or independent processor of the network interfaces 210) to perform functions relating to the techniques described herein.

Specifically, according to various implementations, a device may obtain a prompt to a query service from a client. The device may determine whether a cache containing previously stored prompt-response pairs includes a match for the prompt based on a similarity metric. The device may generate a response to the prompt using a student language model trained on prompt-response data from the cache. The device may determine, based on an assessment of the response generated by the student language model, whether to return the response generated by the student language model to the client or to escalate the prompt to a main language model for response generation.

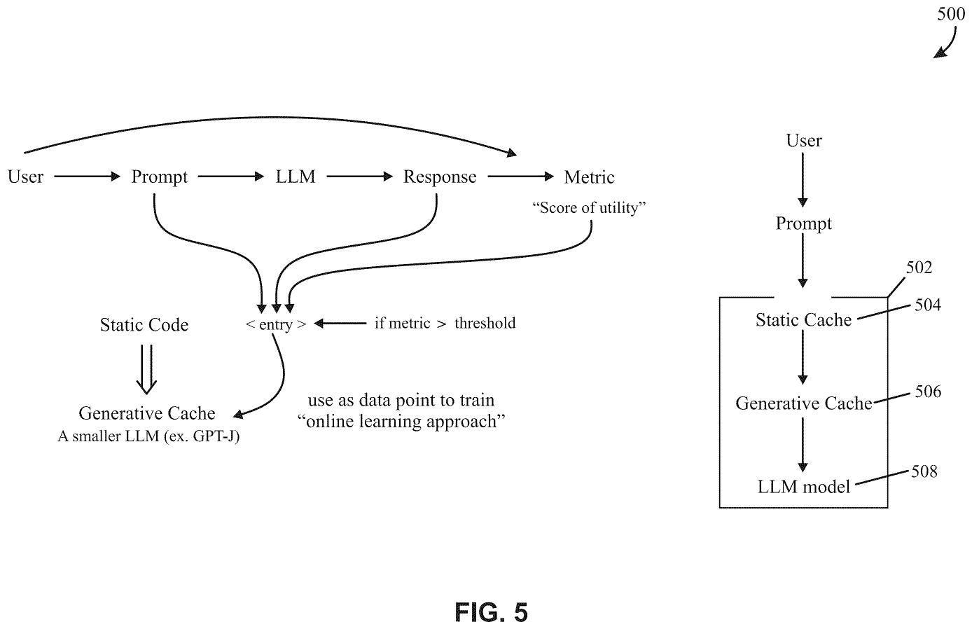

Operationally, FIG. 5 illustrates an example of a framework 500 for hierarchical model training and cache utilization in prompt processing. As discussed above, caching may be leveraged for enhancing performance for a wide variety of applications in distributed computing systems. By caching data and then utilizing that data for subsequent operations, repetition of costly data retrieval and generation operations may be avoided.

As outlined above, there are often computational resource demands associated with language model utilization. That is, there may be a resource costs associated with a language model processing a prompt and/or providing content in response to a prompt. In some instances, a language model may even charge money for providing content.

Successfully caching language model content can reduce the computational resource demands for and performance of accessing language models including by reducing latency, lowering the computational resource requirements/utilization to answer a prompt, by reducing redundant language model utilization, etc. This may represent a significant resource savings opportunity provided by language model caching which is not provided by most other forms of caching. Since language model caching can reduce the computational resource demands of accessing and/or operating language models as well as improve their performance, a caching architecture that provides rapid, accurate, and comprehensive data caching and utilization may be compelling.

Framework 500 may be utilized to deliver such a caching architecture. That is, framework 500 may be utilized to implement a hierarchy of caching/prompt processing strategies configured to escalate resource utilization in order to satisfy a prompt. The framework 500 may incorporate a generative cache, which may include a smaller or less resource-intensive (e.g., than a main language model) student language model, which can generate original prompt responses based on its training by prompts to and/or responses from the main language model.

That is, rather than solely relying on syntactically identical matches in a static cache, the generative caching system may utilize a framework 500, where the same data (e.g., user prompt, system response) is collected, but instead of being just stored, it is used to train a smaller (e.g., than a language model used to generate the initial response) generative model in addition.

This framework 500 may be represented as a hierarchical structure 502 with three potential levels. For example, the hierarchical structure 502 may include a static cache 504, a smaller student model cache 506, and/or a language model 508.

In framework 500, a query may first be checked against the smaller, static cache 504. Then, if there is a cache miss, then the hierarchy may proceed to the smaller student model cache 506 that has been trained using pairs from the static cache 504. The cache miss may be determined based on a comparison of a semantic similarity of a query under process and a cached query in the static cache 504. The smaller model will be faster and reduce the cost over going to the language model 508 for an answer.

This smaller student model cache 506 may facilitate the addition of additional layers of understanding on cached information. This may facilitate the rephrasing and/or answering of broader prompts. In the case of a cache miss at the smaller student model cache 506, the hierarchy may proceed to the language model 508 itself and add its response to the static cache 504 and/or as another training point for the smaller student model cache 506.

In various implementations, an analytics dashboard may be provided with the generative cache components. The dashboard may be configured to show cache entries, settings (such as eviction policy, which responses to use for training the student model), historical performance of the generative cache split by task, and the like.

### Generative Semantic Caching

As noted above, conventional caching mechanisms for language models take a naïve approach that relies on two factors. First, they rely on finding the best matching prompt-response pair. Second, they rely on providing the exact closest match by some form of verification. This matching process is inadequate and does not provide coverage information. In addition, the closest matching the cache may actually return the wrong answer.

In contrast, the techniques herein provide a generative caching system for language models that ensures that cache matches are actually correct. The techniques herein combine graph matching techniques on top of semantic embedding-based matching to provide information regarding coverage. The system may facilitate, when appropriate, a switch to generative caching which uses previously cached items as supporting context while generating results via a language model that utilizes less computational resources (e.g., a small open-source language model such as Llama7B, etc.)

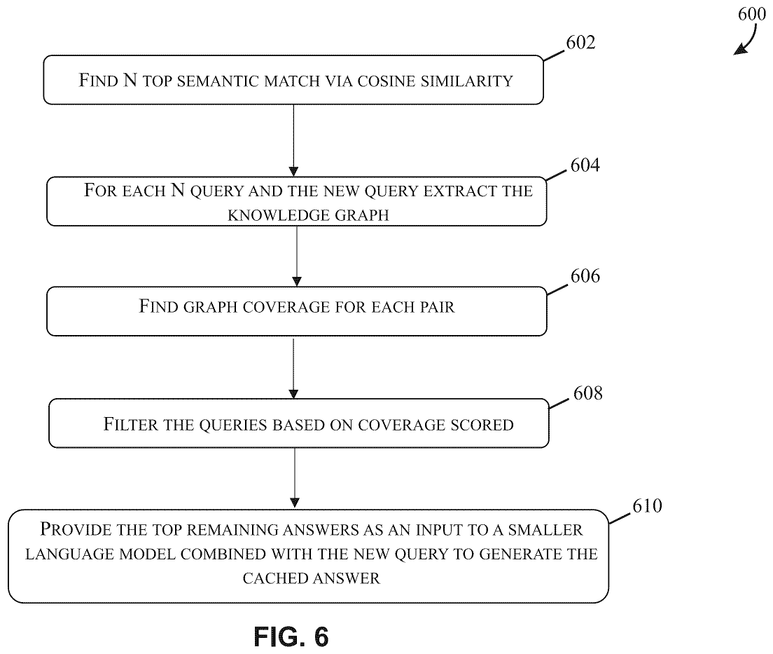

FIG. 6 illustrates an example of a technique 600 for semantic matching with coverage analysis in a generative caching system. In technique 600, N top semantic matches may be found via cosine similarity (e.g., embedding based) at 602. This approach may provide rapid but approximate matching due to embedding matching failing to capture all subtle context matchings.

At 604, technique 600 may include extracting the knowledge graph for each N query and the new query. Then, at 606, technique 600 may include finding graph coverage for each pair (See FIG. 5). At 608, technique 600 may include filtering the queries based on coverage scores. This may include applying a threshold and utilizing all queries that exceed that threshold. Additionally, this may include using mean plus one standard deviation as the threshold, which may be calculated for each set and/or the fixed threshold may be applied across all searches).

At 610, the technique 600 may include providing the top remaining matches as in input to a smaller language model combined with the new query to generate the cached answer. The smaller language model can be an open-source language model (e.g., a 7B open-source LLM such as Llama 2 or similar). Alternatively, the smaller version can be a cheaper language model (e.g., less computational resource intensive utilization) from the same cloud provider. For instance, the actual content and answer to questions may be provided by GPT4, which may have a relatively high computational resource demand, and the generative cache be generated by the chatGPT3.5 which may have a relatively cheaper computational resource demand. Also given the answer from the larger model is given which itself may have used large context by incorporating RAG, long context may not be needed as the query+question/answer from cache will not be as large.

In various implementations, a graduated set of matching rules ordered from simple to complex may be utilized in technique 600. Elastic search may be applied to the first matches to create a short list. Semantic matching may then be applied on the shortlist (e.g., send top N, use cosine similarity, etc.) to create a second short list. Graph matching may be applied on the second short list to create a third short list. The third short list may be sent as context to a small, relatively low computational demand language model to generate a response.

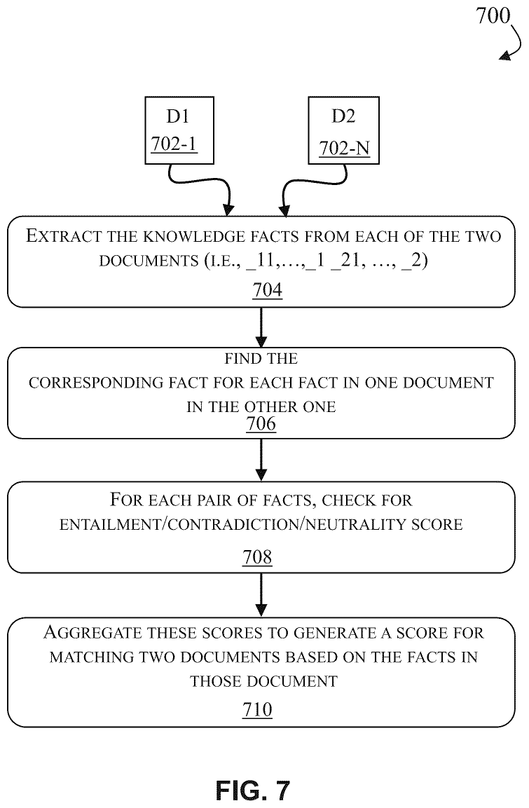

FIG. 7 illustrates an example of a technique 700 for graph matching in a generative caching system. Technique 700 may be utilized to perform graph matching on documents 702. This may include assigning a similarity score to these documents 702.

At 704, knowledge facts may be extracted from each of the documents 702 (e.g., _11, . . . , 1 _21, . . . , _2). Then, at 706, corresponding facts in the documents 702 may be identified. For instance, by using a text embedding model a conversion of each f_i to e_i and for each pair of e_1i and e_2j may be performed to compute the similarity score via cosine similarity. This way, the system can find the corresponding fact for each fact in one document in the other one.

At 708, for each fact in a first document 702-1 for which the corresponding fact in a second document 702-N is identified as mentioned above, a check of entailment/contradiction/neutrality score (e.g., 1, −1, and 0 correspondingly) may be performed for this pair of facts (e.g., using a fine-tuned BERT model for the entailment task, using another small language model (e.g. 1B open source Llama model), etc.) and some in-context-learning examples may be provided. At 710, the determined scores may be aggregated to generate a matching score. For example, by averaging these scores, a score for matching two documents based on the facts in those documents may be generates (e.g., 1 for complete agreement and −1 for complete disagreement). Other forms of aggregation other than averaging may be appropriate for certain use cases. For instance, the existence of contradiction may be emphasized by increasing the importance of it in the final score (i.e. replacing −1 for contradiction to −K).

In various implementations, this approach may contain three levels with thresholds appropriate for selecting any number of candidates for each level (e.g., elastic search, crude semantic search, and fine-grained graph matching). The parameters of the graph matching approach may be comprised of −K for the effect of the contradiction, as well as the finetuned entailment model or the ICL entailment via an open-source language model of the choice by user. In addition to the configurations, the system can provide detailed information for the matching criteria and quality and this information can be effectively used by the system to decide when/if to ignore the generative cache and generate new content by the larger language model instead For instance, this decision may be based on the threshold scores provided by the user for each level of matching, and even a rule-based approach for the graph matching (e.g. the lack of any contradiction).

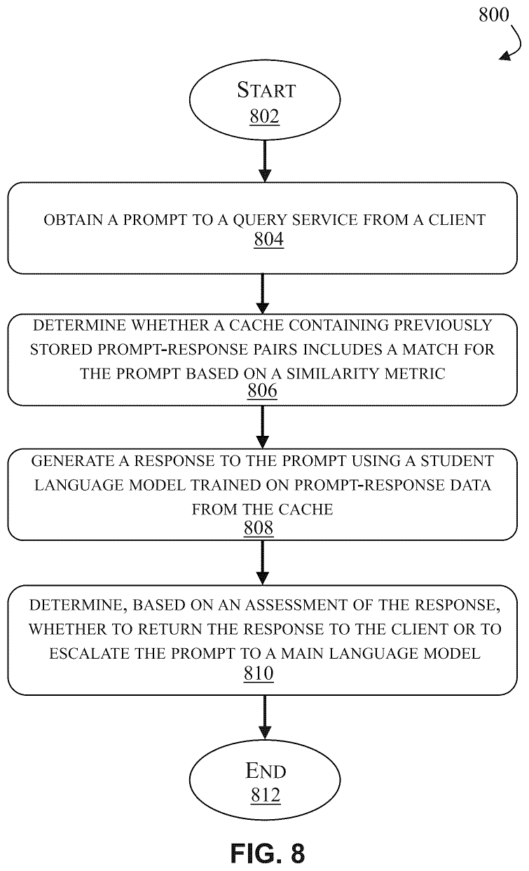

FIG. 8 illustrates an example of a simplified procedure 800 for generative cache utilization in natural language prompt processing in accordance with one or more implementations described herein. For example, a non-generic, specifically configured device (e.g., device 200), may perform procedure 800 (e.g., a method) by executing stored instructions (e.g., generative caching process 248).

The procedure may start at step 802, and continues to step 804, where, as described in greater detail above, the device (e.g., a controller, processor, etc.) may obtain a prompt to a query service (e.g., which may include a language model) from a client. The prompt may include a query directed to one or more large language models. That is, the prompt may be directed to one or more main language model that the client has previously interacted with and/or received responses from. These previous prompts and/or responses may be stored in a cache. The prompt may be intercepted and/or processed prior to submission to the one or more main language models.

At step 806, the device may determine whether a cache containing previously stored prompt-response pairs includes a match for the prompt based on a similarity metric. The cache may, in some instances, be a static cache. A stored prompt-response may be identified as a match for the prompt based on a comparison of a semantic similarity metric between the prompt and the stored prompt-response to a similarity threshold.

In various implementations, a stored prompt-response may be identified as a match for the prompt by extracting knowledge graphs for the prompt and stored prompt-response match candidates and/or filtering the stored prompt-response match candidates based on graph coverage scores associated with each of the knowledge graphs. For example, the device may identify corresponding facts between the prompt and each of the stored prompt-response match candidates, evaluate each pair of corresponding facts for one or more of entailment, contradiction, or neutrality using a trained model and/or generate the graph coverage scores for each of the stored prompt-response match candidates based on evaluation of the corresponding facts.

In various implementations, a parameter may be applied to amplify an impact of contradictions in a calculation of the graph coverage scores such that candidate responses containing contradictory facts are weighted negatively. The stored prompt-response match candidates may be filtered based on a comparison of the graph coverage scores associated with each of the knowledge graphs to a threshold calculated based on one or more of a user defined threshold or a mean plus one standard deviation of graph coverage scores. The stored prompt-response match candidates remaining after filtering may be provided as an input to a student language model along with the prompt.

At step 608, the device may generate a response to the prompt using a student language model trained on prompt-response data from the cache. The student language model is a smaller and/or less resource intensive language model than the main language model. The student language model may be configured to operate as a generative cache that generates original responses to prompts which may not have been received before utilizing prior cached prompt-response pairs that are related to those prompts. The response generated by the student language model may then be added to the cache.

At step 810, the device may determine, based on an assessment of the response generated by the student language model, whether to return the response generated by the student language model to the client or to escalate the prompt to a main language model for response generation. The student language model may be used to generate the response only when coverage scores associated with knowledge graphs for the prompt and stored prompt-response matches meet a threshold. Conversely, if the threshold is not met, the prompt may be directed to the main language model for response generation.

It should be noted that while certain steps within the described techniques (e.g., technique 600, technique 700, procedure 800, etc.) may be optional as described above, the steps shown in FIG. 6, FIG. 7, FIG. 8, etc. are merely examples for illustration, and certain other steps may be included or excluded as desired. Further, while a particular order of the steps is shown, this ordering is merely illustrative, and any suitable arrangement of the steps may be utilized without departing from the scope of the implementations herein.

The techniques described herein, therefore, introduce a mechanism for generative semantic caching and model distillation in natural language processing. The techniques introduce a hierarchical caching framework that utilizes a static cache, a trained student language model as a generative cache, and/or a main language model to efficiently process and respond to queries with reduced computational resource demands. By first attempting to match queries in a static cache, the framework quickly returns responses for frequently repeated queries.

For queries not addressed in the static cache, the trained student model may generate contextually relevant responses based on a multi-level matching process, which may include keyword-based, semantic similarity, and graph-based matching to ensure alignment with the query's relational context. In cases where the student model response does not meet various criteria, the framework can escalate to the main language model, preserving system resource while maintaining response accuracy.

For example, in distributed computing systems, this caching hierarchy enables faster response times, less dependency on high-computation models, and reduced latency in delivering responses. The system's ability to evaluate queries against configurable thresholds, such as semantic similarity and factual consistency, provides concrete criteria for determining when to rely on cached or generated responses, allowing it to scale across various resource conditions and application requirements. This multi-level caching strategy thus enables a practical, resource-sensitive approach to handling high volumes of queries while achieving reliable, accurate query fulfillment.

While there have been shown and described illustrative implementations that provide for generative semantic caching and model distillation in natural language processing, it is to be understood that various other adaptations and modifications may be made within the spirit and scope of the implementations herein. For example, while certain implementations are described herein with respect to using certain elements, modules, components, architectures, etc. for the purposes of generative caching for natural language, the elements, modules, components, architectures, etc. are not limited as such and may be used for other functions, in other arrangements, in other functional distributions, in other implementations, etc.

The foregoing description has been directed to specific implementations. It will be apparent, however, that other variations and modifications may be made to the described implementations, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the implementations herein. Therefore, it is the object of the appended claims to cover all such variations and modifications as come within the true spirit and scope of the implementations herein.

What is claimed is:

1. A method, comprising:
obtaining, by a device, a prompt to a query service from a client;
determining, by the device, whether a cache containing previously stored prompt-response pairs includes a match for the prompt based on a similarity metric;
generating, by the device, a response to the prompt using a student language model trained on prompt-response data from the cache; and
determining, by the device and based on an assessment of the response generated by the student language model, whether to return the response generated by the student language model to the client or to escalate the prompt to a main language model for response generation.

2. The method as in claim 1, further comprising:
identifying a stored prompt-response as a match for the prompt based on a comparison of a semantic similarity metric between the prompt and the stored prompt-response to a similarity threshold.

3. The method as in claim 1, wherein the student language model is a smaller language model than the main language model.

4. The method as in claim 1, further comprising:
identifying a stored prompt-response as a match for the prompt by:
extracting knowledge graphs for the prompt and stored prompt-response match candidates; and
filtering the stored prompt-response match candidates based on graph coverage scores associated with each of the knowledge graphs.

5. The method as in claim 4, further comprising:
identifying corresponding facts between the prompt and each of the stored prompt-response match candidates;
evaluating each pair of corresponding facts for one or more of entailment, contradiction, or neutrality using a trained model; and
generating the graph coverage scores for each of the stored prompt-response match candidates based on evaluation of the corresponding facts.

6. The method of claim 5, further comprising:
applying a parameter to amplify an impact of contradictions in a calculation of the graph coverage scores such that candidate responses containing contradictory facts are weighted negatively.

7. The method as in claim 4, further comprising:
filtering the stored prompt-response match candidates based on a comparison of the graph coverage scores associated with each of the knowledge graphs to a threshold calculated based on one or more of a user defined threshold or a mean plus one standard deviation of graph coverage scores.

8. The method as in claim 7, further comprising:
providing stored prompt-response match candidates remaining after filtering as an input to the student language model along with the prompt.

9. The method as in claim 1, wherein the student language model is used to generate the response only when coverage scores associated with knowledge graphs for the prompt and stored prompt-response matches meet a threshold, and wherein, if the threshold is not met, the prompt is directed to the main language model for response generation.

10. The method as in claim 1, further comprising:
adding the response generated by the student language model to the cache.

11. An apparatus, comprising:
one or more network interfaces;
a processor coupled to the one or more network interfaces and configured to execute one or more processes; and
a memory configured to store a process that is executable by the processor, the process when executed configured to:
obtain a prompt to a query service from a client;
determine whether a cache containing previously stored prompt-response pairs includes a match for the prompt based on a similarity metric;
generate a response to the prompt using a student language model trained on prompt-response data from the cache; and
determine, based on an assessment of the response generated by the student language model, whether to return the response generated by the student language model to the client or to escalate the prompt to a main language model for response generation.

12. The apparatus as in claim 11, the process further executable to:
identify a stored prompt-response as a match for the prompt based on a comparison of a semantic similarity metric between the prompt and the stored prompt-response to a similarity threshold.

13. The apparatus as in claim 11, wherein the student language model is a smaller language model than the main language model.

14. The apparatus as in claim 11, the process further executable to identify a stored prompt-response as a match for the prompt by:
extracting knowledge graphs for the prompt and stored prompt-response match candidates; and
filtering the stored prompt-response match candidates based on graph coverage scores associated with each of the knowledge graphs.

15. The apparatus as in claim 14, the process further executable to:
identify corresponding facts between the prompt and each of the stored prompt-response match candidates;
evaluate each pair of corresponding facts for one or more of entailment, contradiction, or neutrality using a trained model; and
generate the graph coverage scores for each of the stored prompt-response match candidates based on evaluation of the corresponding facts.

16. The apparatus as in claim 15, the process further executable to:
apply a parameter to amplify an impact of contradictions in a calculation of the graph coverage scores such that candidate responses containing contradictory facts are weighted negatively.

17. The apparatus as in claim 14, the process further executable to:
filter the stored prompt-response match candidates based on a comparison of the graph coverage scores associated with each of the knowledge graphs to a threshold calculated based on one or more of a user defined threshold or a mean plus one standard deviation of graph coverage scores.

18. The apparatus as in claim 17, the process further executable to:
provide stored prompt-response match candidates remaining after filtering as an input to the student language model along with the prompt.

19. The apparatus as in claim 11, wherein the student language model is used to generate the response only when coverage scores associated with knowledge graphs for the prompt and stored prompt-response matches meet a threshold, and where, if the threshold is not met, the prompt is directed to the main language model for response generation.

20. A tangible, non-transitory, computer-readable medium storing program instructions that cause a device to execute a process comprising:
obtaining a prompt to a query service from a client;
determining whether a cache containing previously stored prompt-response pairs includes a match for the prompt based on a similarity metric;
generating a response to the prompt using a student language model trained on prompt-response data from the cache; and
determining, based on an assessment of the response generated by the student language model, whether to return the response generated by the student language model to the client or to escalate the prompt to a main language model for response generation.
